(19) United States
(12) Patent Application Publication
(10) Pub. No.: US 2003/0172004 A1
(43) Pub. Date: Sep. 11, 2003

(54) Sales voting and shopping by recipient attributes

(75) Inventor: Glen J. Anderson, Sioux City, IA (US)

Correspondence Address: Gateway, Inc., Attn: Mark Walker, Law Department, MS Y04, 610 Gateway Drive, Box 2000, N. Sioux City, SD, 57049-2000, US

(73) Assignee: Gateway, Inc.

(21) Appl. No.: 10/093,024

(22) Filed: Mar. 7, 2002

(51) Int. Cl. G06F 17/60

(52) U.S. Cl. 705/27

(57) ABSTRACT

The present invention is an apparatus and method for providing enhanced product review to an online shopper prior to purchase. An online business may provide a computer-implemented service that allows an online shopper to request advice from other online shoppers who match certain desired attributes to obtain an indication about a certain product. The online business may also provide results of a vote regarding which one product of a group of products is considered the best product. In exchange for a user's participation in the service, each user may receive a coupon or discount towards the purchase of products available through the online business.

### FIELD OF THE INVENTION

The present invention generally relates to the field of online purchasing, and more particularly to an apparatus and method for providing enhanced product review to an online shopper prior to purchase.

### BACKGROUND OF THE INVENTION

When purchasing a product, it is often helpful to receive advice from another party. During the purchase of a gift, it is especially helpful to receive advice from another party who may share the same attributes as the gift recipient. For example, if a person is buying a video game for a male teenager, it may be helpful to receive advice regarding video games from another male teenager. When shopping at a retail location, this advice may be obtained by speaking with a sales clerk or a fellow shopper that has the same characteristics as the gift recipient.

In the realm of online shopping where a consumer purchases a product from a business through a web site maintained by the business, receiving advice and support concerning the purchase of particular products is generally not possible. Also, when shopping for products that are available in multiple sizes such as clothing, it is typically difficult to determine the appropriate size from a picture. Consequently, an apparatus and method for providing enhanced product review to an online shopper prior to purchase is necessary.

### SUMMARY OF THE INVENTION

Accordingly, the present invention is directed to an apparatus and method for providing enhanced product review to an online shopper prior to purchase. In one embodiment of the invention, an online business may provide an apparatus to allow an online shopper to request advice from a desirable test group of other online shoppers who match certain desired attributes to obtain an indication about a certain product. In one aspect of the invention, an online shopper may request a vote between one of a few products from other online shoppers who match certain desired attributes. In yet another embodiment of the invention, an online business may provide the attributes of people that purchased the products and attributes of the people that received the products.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts a block diagram representing an embodiment of an apparatus of the present invention;

FIG. 2 is an embodiment of a process for allowing a user to request and receive a product review from a desirable test group regarding a particular product;

FIG. 3 is an embodiment of a process for providing a user with a product review from a desirable test group regarding the selection of a best product from a group of products;

FIG. 4 is an embodiment of a process for providing a product review regarding the quantity of sales of a product and the characteristics of the purchasers;

FIG. 5 is an embodiment of a process for providing a most popular wish list of a desirable test group in accordance with the present invention;

FIG. 6 depicts an embodiment of a presentation of typical results received by a user upon a product review request in accordance with the present invention; and

FIG. 7 is a block diagram of an information handling system of the present invention.

### DETAILED DESCRIPTION OF THE INVENTION

Reference will now be made in detail to the presently preferred embodiments of the invention, examples of which are illustrated in the accompanying drawings.

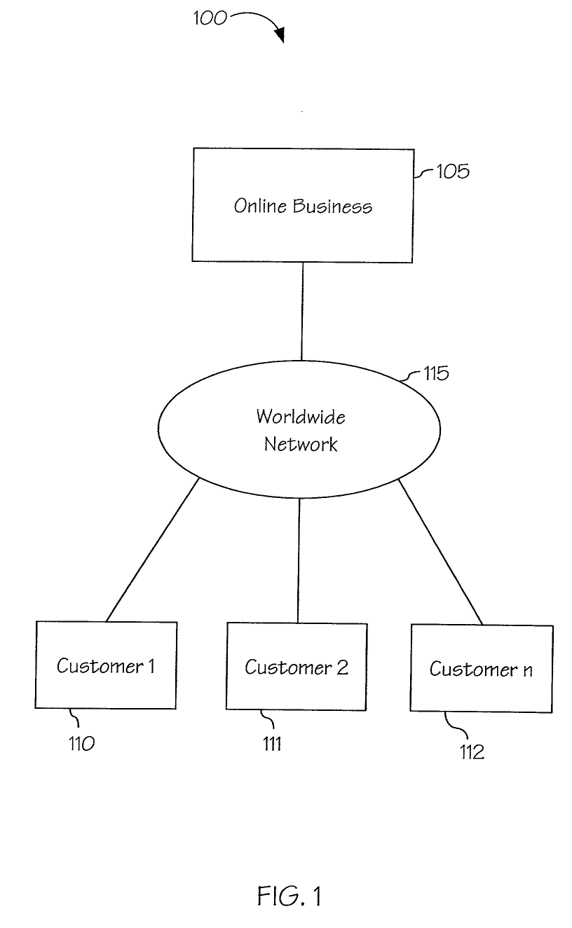

Referring to FIG. 1, an embodiment of an apparatus 100 of the present invention is shown. An online business 105 may be accessed by multiple customers 110-112 through a worldwide network 115. In one embodiment of the invention, a worldwide network may be the Internet including a worldwide collection of networks and gateways that use the TCP/IP suite of protocols to communicate with each other. An online business may be a web site wherein a customer 110-112 may access the web site via a connection to the Internet to purchase products from the business maintaining the web site. In such a fashion, an online business 105 may synchronously retrieve sales orders from customers in multiple locations providing an efficient method to provide products and services for sale.

An advantageous aspect of the present invention is the ability to provide access to customers 110-112 in multiple locations while providing support and feedback concerning the purchase of a particular product. In an embodiment of the invention, an online business may execute a computer-implemented service of the present invention that may employ a web site that executes a program of instructions. The execution of a program of instructions may allow a user to request and obtain a product review from a desirable test group that includes other online shoppers regarding the purchase of a particular product. In one embodiment of the invention, the computer-implemented service may be accomplished with web-based chat technology and online meeting web site technology.

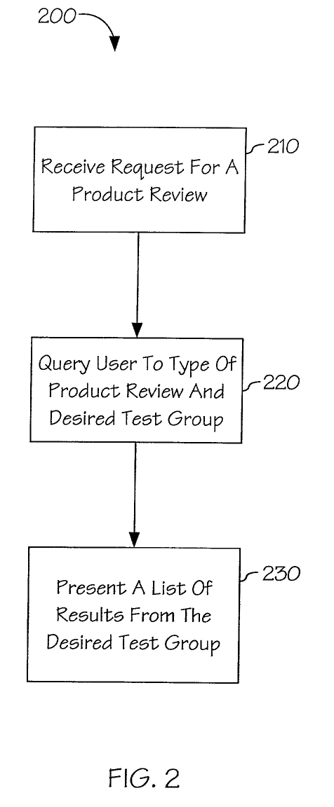

Referring now to FIG. 2, an embodiment of a process 200 for allowing a user to request and receive a product review from a desirable test group regarding a particular product is shown. It should be understood by one of ordinary skill in the art that the term product may not only refer to a tangible good but may also include any device, machine, service, arrangement, vacation, trip, commodity, and the like without departing from the scope and spirit of the present invention. The process 200 may begin upon the receipt of a request for a product review concerning a particular product from a user 210. The request may be accomplished by the activation of an icon located on a page of a web site as the user is browsing products shown on a web site maintained by an online business.

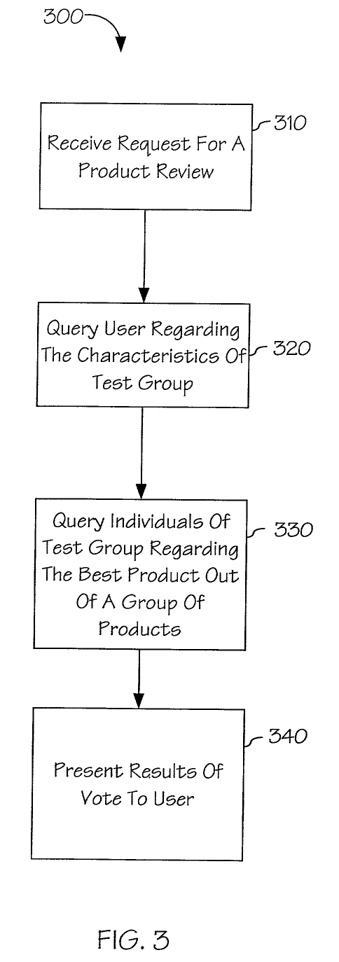

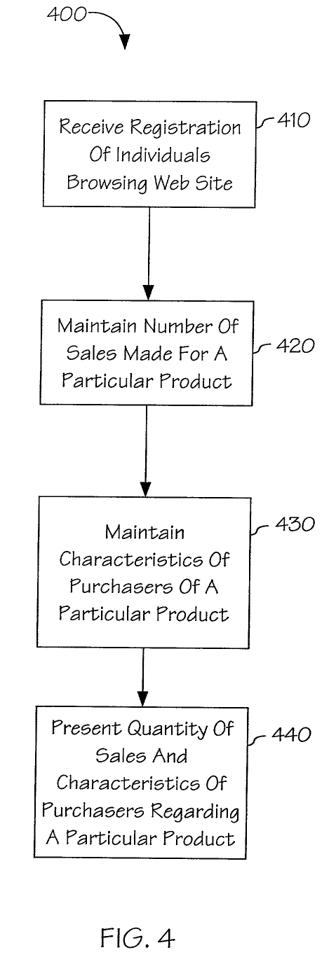

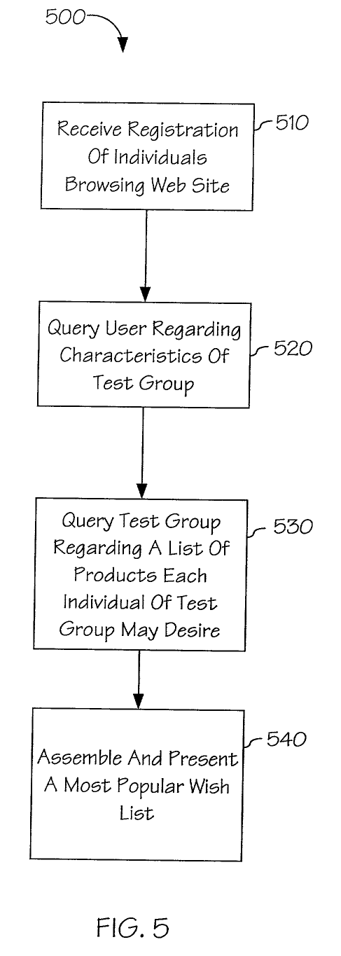

Once a request has been received, the user may be queried to the type of product review and the desired test group 220. In such a fashion, a user may request feedback from a single or a selected number of individuals with certain attributes. For example, a user could request feedback from women, aged twenty years old to thirty years old, who live in New York state. In an alternative embodiment, individuals with certain characteristics may be excluded from a desired test group. Further, the user may be provided with multiple types of product reviews including an assembly of comments, a vote of a best product (FIG. 3), a statistical analysis of sales (FIG. 4), and a most popular wish list (FIG. 5). Upon assembly of the results, a list of results of the desired test group may be presented. Comments and feedback from members of the desired test group having certain attributes may be assembled and provided to the user 230.

In one embodiment of the invention, comments and feedback from members of the desired test group may be received through implementation of process 200 of the present invention in real-time. Process 200 may employ web-based chat technology such that comments and feedback may be presented to a user in real-time. In an alternative embodiment of the present invention, a product review performed by a member of a test group may be stored. This may allow a presentation of a product review by a test group at a later time allowing a user to visit a web-site at a later time to view the results of the test group. It should be understood by those with ordinary skill in the art that a user may be capable of making a selection, then, reviewing the results of a test group prior to making a final decision whether to purchase a particular product.

An online business, in the registration of its users, may request that each user provide certain characteristics about themselves. These characteristics may include age, sex, geographical location, occupation, annual income, number of children, marital status, height, weight, build and the like. By providing the size and weight of individuals, a user may receive feedback concerning the size and fit of clothing. In alternative embodiments of the invention, a user's measurements or a photograph of a user may be made available for comparison. When viewing a particular piece of clothing from a picture placed upon a web site, it may be difficult to determine whether the product may run small or larger than normal. Thus, an advantageous aspect of the present invention lies in the ability to receive feedback from other users regarding the size of a particular piece of clothing. In exchange for user participation in product reviews as described in FIGS. 2, 3, 4, and 5, a user may receive a coupon or a discount that may be utilized towards the purchase of a product with an online business of the present invention. Other incentives known to the art may also be employed without departing from the scope and spirit of the present invention.

Referring now to FIG. 3, an embodiment of a process for providing a user with a product review from a desirable test group regarding the selection of a best product from a group of products is shown. Process 300 may begin upon the receipt of a request for a product review concerning a particular product 310. A next step may be the query of a user regarding the characteristics of a test group 320. A group of individuals fitting within the characteristics of the test group may be shown multiple products. Each of the individuals may be queried regarding which product they would desire the most out of the multiple products 330. The results of the vote may be presented to the user to aid in the selection of the product 340.

Referring now to FIG. 4, an embodiment of a process 400 for providing a product review regarding the quantity of sales of a product and the characteristics of the purchasers is shown. The process 400 may begin by the receipt of a registration of individuals browsing the web site 410. Included within the registration, a user may be queried regarding particular attributes of the user. As purchases are made, a database of the number of sales made for each particular type of product is maintained 420. In addition, the characteristics of each individual purchaser for each particular product may also be maintained 430. Thus, the quantity of sales and the characteristics of the purchasers may be presented to an online shopper 440 to aid in the selection of a product.

Referring now to FIG. 5, an embodiment of a process 500 for providing a most popular wish list of a desirable test group in accordance with the present invention is shown. The process 500 may begin by receiving the registration of individuals browsing the web site 510 of an online business employing the process 500 of the present invention. The process may continue by querying the user regarding the desirable characteristics of the test group 520. Individuals may be queried regarding a list of products that each individual may desire 530. In one embodiment of the invention, each individual may be queried for a desired wish list during registration. The wish lists of multiple individuals from a desired test group may be assembled to produce a most popular wish list 540. In one embodiment of the invention, multiple lists of desirable products may be assembled by a process performed by a computer-implemented service of the present invention according to specific price ranges. An online shopper, desiring assistance regarding the selection of a gift, may refer to a most popular wish lift of the present invention.

In another embodiment of the invention, an online shopper may refer to a wish list of a particular individual of a test group to obtain assistance in the selection of a product. For example, a user may have similar interests as a particular user and may really value their opinion. The method of the present invention may provide the wish list of a particular individual upon receipt of such a request from an online shopper. In another embodiment of the invention, the desired test group may be formed such that a single desirable individual is the only member of the test group. It should be understood by those with ordinary skill in the art that the principle of seeking advice from a particular individual of a test group may be implemented in accordance with processes 200, 300, 400, and 500 of the present invention without departing from the scope and spirit of the present invention. Further, a process of the present invention performed an online business may ensure that a particular user is only known by other online shoppers through a pseudo-name only thus ensuring privacy for each user.

While in the embodiments of the invention discuss a test group made up of individuals, it should be understood that a test group may include a collection of entities other than individual people without departing from the scope and spirit of the present invention. For example, a test group may include a group of small businesses, organizations, schools and the like.

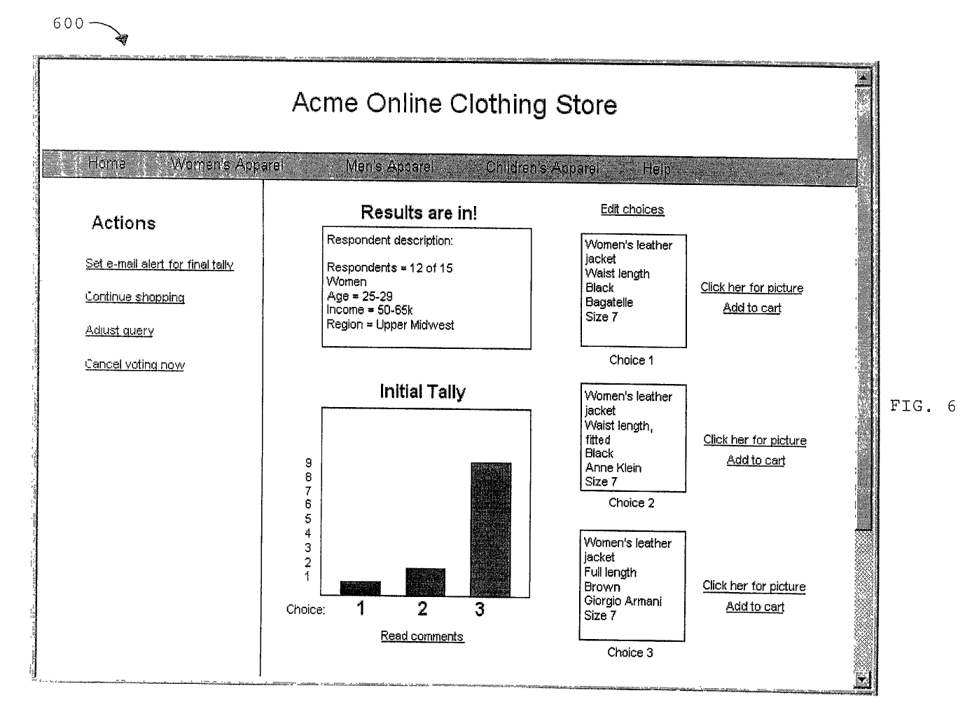

Referring to FIG. 6, an embodiment of a presentation 600 of typical results received by a user upon a product review request in accordance with the present invention is shown. The presentation 600 may be representative of the presentation of results from a query as described in box 230 of FIG. 2. In one embodiment of the invention, presentation 600 may include a list of choices for the test group, the characteristics of the test group, the results of the test group, and an icon to retrieve comments from the test group.

Presentation 600 may further include a graphical display which depicts the results of the query and provides a mechanism for a user to easily understand the results of the query. For example, presentation 600 may include a bar graph that depicts the results of a vote of a test group. In the embodiment as shown in FIG. 6, the presentation of results may be implemented and may be suitable for an embodiment of process 300 of the present invention. However, it should be understood by those with ordinary skill in the art that presentation 600 may be produced for processes 200, 300, 400 and 500 of the present invention without departing from the scope and spirit of the present invention.

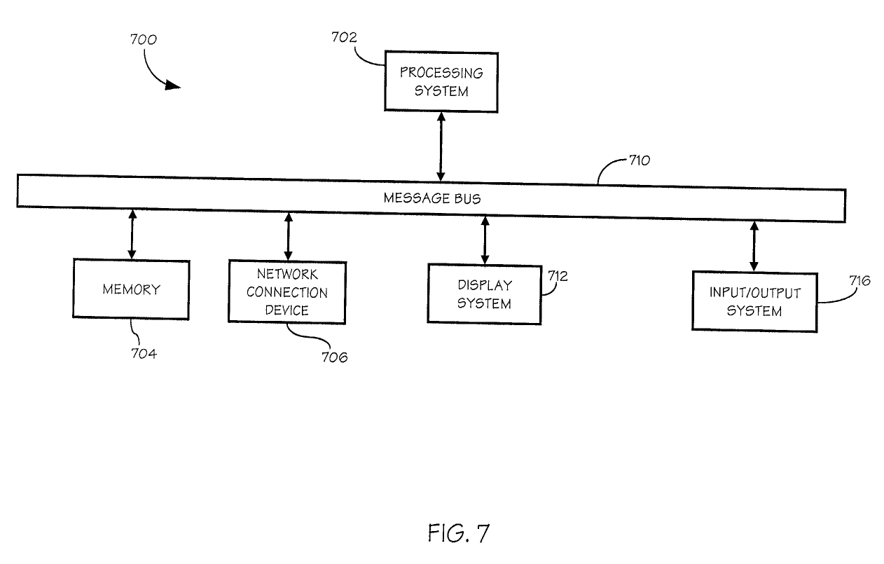

Referring now to FIG. 7, a hardware system in accordance with the present invention is shown. The hardware system shown in FIG. 7 is generally representative of a preferred hardware architecture of an information handling system 700 of the present invention. In one embodiment of the invention, information handling system 700 may be capable of performing processes 200, 300, 400, and 500 of the present invention depicted in FIGS. 2-5. A controller, for example, a processing system 702, controls the information handling system 700. The processing system 702 includes a central processing unit such as a microprocessor or microcontroller for executing programs, performing data manipulations and controlling the tasks of the information handling system 700. Communication with the processing system 702 may be implemented through a message or system bus 710 for transferring information among the devices of the information handling system 700. The system bus 710 may include a data channel for facilitating information transfer between storage and other peripheral devices of the information handling system 700. The system bus 710 further provides the set of signals required for communication with processing system 702 including a data bus, address bus, and control bus. The system bus 710 may comprise any state of the art bus architecture according to promulgated standards, for example industry standard architecture (ISA), extended industry standard architecture (EISA), Micro Channel Architecture (MCA), peripheral device interconnect (PCI) local bus, standards promulgated by the Institute of Electrical and Electronics Engineers (IEEE) including IEEE 488 general-purpose interface bus (GPIB), IEEE 696/S-600, and so on. Furthermore, the system bus 710 may be compliant with any promulgated industry standard. For example, the system bus 710 may be designed in compliance with any of the following bus architectures: Industry Standard Architecture (ISA), Extended Industry Standard Architecture (EISA), Micro Channel Architecture, Peripheral Device Interconnect (PCI), Universal Serial Bus (USB), Access bus, IEEE P6394, Apple Desktop Bus (ADB), Concentration Highway Interface (CHI), Fire Wire, Geo Port, or Small Computer Systems Interface (SCSI), as examples.

Additionally, the information handling system 700 includes a memory 704. In one embodiment, memory 704 is provided on SIMMs (Single In-line Memory Modules), while in another embodiment, memory 704 is provided on DIMMs (Dual In-line Memory Modules), each of which plugs into suitable sockets provided on a motherboard holding many of the other devices shown in FIG. 7. Memory 704 includes standard DRAM (Dynamic Random-Access Memory), EDO (Extended Data Out) DRAM, SDRAM (Synchronous DRAM), or other suitable memory technology. Memory 704 may also include auxiliary memory to provide storage of instructions and data that are loaded into the memory 704 before execution. Auxiliary memory may include semiconductor based memory such as read-only memory (ROM), programmable read-only memory (PROM) erasable programmable read-only memory (EPROM), electrically erasable read-only memory (EEPROM), or flash memory (block oriented memory similar to EEPROM).

The information handling system 700 may include a network connection device or a network interface 706. The network interface 706 communicates between the information handling system 700 and a remote device, such as external devices, networks, information sources, or host systems that administer a plurality of information appliances. For example, host systems such as a server or information handling system, may run software controlling the information handling system 700, serve as storage for an information handling system 700, or coordinate software running separately on each information handling system 700. The network interface 706 may provide or receive analog, digital, or radio frequency data. The network interface system 706 preferably implements industry promulgated architecture standards, including Recommended Standard 232 (RS-232) promulgated by the Electrical Industries Association, Infrared Data Association (IrDA) standards, Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, 802.66 for wireless networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and Universal Serial Bus (USB), as examples. For example, the network interface system 706 may comprise a network adapter, a serial port, parallel port, printer adapter, modem, universal asynchronous receiver-transmitter (UART) port, etc., or use various wireless technologies or links such as an infrared port, radio-frequency (RF) communications adapter, infrared transducers, or RF modem.

The information handling system 700 may preferably include a display system 712. This may allow for a generation of a display when an information handling system 700 is connected to a display device. The display system 712 may comprise a video display adapter having all of the devices for driving the display device, including video random access memory (VRAM), buffer, and graphics engine as desired. A display device may comprise a liquid-crystal display (LCD), or may comprise alternative display technologies, such as a light-emitting diode (LED) display, gas or plasma display, or employ flat-screen technology.

An information handling system 700 may further include an input/output (I/O) system 716. This may allow for user input via I/O devices when I/O devices are connected to information handling system 700. Input/output system 716 may comprise one or more controllers or adapters for providing interface functions between one or more I/O devices. For example, input/output system 716 may comprise a serial port, parallel port, network adapter, printer adapter, radio-frequency (RF) communications adapter, universal asynchronous receiver-transmitter (UART) port, etc., for interfacing between corresponding I/O devices such as a mouse, joystick, trackball, trackpad, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, touch screen, stylus, electroacoustic transducer, microphone, speaker, etc. It should be appreciated that modification or reconfiguration of the information handling system 700 of FIG. 7 by a person of ordinary skill in the art would not depart from the scope or the spirit of the present invention.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method of providing enhanced product review for an online shopper, comprising:
(a) receiving a request for a product review from a user;
(b) querying said user regarding a type of said product review; and
(c) presenting a list of results from said product review; wherein a review from at least one individual having a desired set of characteristics is assembled to form said list of results to assist said user in a selection of a product.

2. The method as claimed in claim 1, wherein a number of said at least one individual having said desired set of characteristics is chosen by said user.

3. The method as claimed in claim 1, wherein said request is initiated upon activation of a function by said user.

4. The method as claimed in claim 1, wherein said type of review is a statistical analysis of a number of sold products and a set of characteristics of purchasers who purchased products.

5. The method as claimed in claim 1, wherein said type of product review is a vote regarding the selection of a best product from a group of multiple products.

6. The method as claimed in claim 1, wherein said type of review is the presentation of a wish list of desirable products.

7. The method as claimed in claim 1, wherein said product includes a tangible good, service, trip, vacation and device.

8. The method as claimed in claim 1, wherein said desired set of characteristics includes at least one of age, size, sex, marital status, income, and occupation, and geographic location.

9. The method as claimed in claim 1, wherein said review from said at least one individual having a desired set of characteristics is performed and presented to said user in real-time with a user's shopping experience.

10. A method of providing enhanced product review for an online shopper, comprising:
(a) receiving a request for a product review from a user;
(b) querying said user regarding a set of characteristics for a test group;
(c) querying each member of said test group having said set of characteristics regarding a best product of a group of products; and
(d) presenting a list of results from said test group concerning said best product of said group of products

11. The method as claimed in claim 10, wherein said request is initiated upon activation of a function by said user.

12. The method as claimed in claim 10, wherein said product includes a tangible good, service, trip, vacation and device.

13. The method as claimed in claim 10, wherein said set of characteristics includes at least one of age, size, sex, marital status, income, and occupation, and geographic location.

14. The method as claimed in claim 10, wherein a number of members of said test group is selectable by said user.

15. The method as claimed in claim 10, wherein said list of results is presented to said user in real-time with a user's shopping experience.

16. A method of providing enhanced product review for an online shopper, comprising:
(a) receiving a registration of individuals visiting a site;
(b) maintaining a number of sales for at least one product;
(c) maintaining a set of characteristics of purchasers of said at least one product; and
(d) presenting a list of results regarding said at least one product, said list of results including said number of sales and said set of characteristics of purchasers.

17. The method as claimed in claim 16, wherein said at least one product includes a tangible good, service, trip, vacation and device.

18. The method as claimed in claim 16, wherein said set of characteristics includes at least one of age, size, sex, marital status, income, and occupation, and geographic location.

19. The method as claimed in claim 16, wherein said set of characteristics of purchasers is determined through said registration of individuals visiting a site.

20. A method of providing enhanced product review for an online shopper, comprising:
(a) receiving a registration of individuals visiting a site;
(b) querying a user regarding a set of characteristics of a test group;
(c) querying said test group regarding a desirable list of products of each member of said test group; and
(d) presenting a most popular wish list from said desirable list of products of each member of said test group to said user.

21. The method as claimed in claim 20, wherein said at desirable list of products includes a tangible goods, services, trips, vacations and devices.

22. The method as claimed in claim 20, wherein said set of characteristics includes at least one of age, size, sex, marital status, income, and occupation, and geographic location.

23. An apparatus for providing enhanced product review for an online shopper, comprising:
(a) means for receiving a request for a product review from a user;
(b) means for querying said user regarding a type of said product review based upon said request; and
(c) means for presenting a list of results from said product review, said list of results corresponding to said type of product review desired, wherein a review from at least one individual having a desired set of characteristics is assembled to form said list of results to assist said user in a selection of a product.

24. The apparatus as claimed in claim 23, wherein a number of said at least one individual having said desired set of characteristics is chosen by said user.

25. The apparatus as claimed in claim 23, wherein said request is initiated upon activation of a function by said user.

26. The apparatus as claimed in claim 23, wherein said type of review is a statistical analysis of a number of sold products and a set of characteristics of purchasers who purchased products.

27. The apparatus as claimed in claim 23, wherein said type of product review is a vote regarding the selection of a best product from a group of multiple products.

28. The apparatus as claimed in claim 23, wherein said type of review is the presentation of a wish list of desirable products.

29. The apparatus as claimed in claim 23, wherein said product includes a tangible good, service, trip, vacation and device.

30. The apparatus as claimed in claim 23, wherein said desired set of characteristics includes at least one of age, size, sex, marital status, income, and occupation, and geographic location.
